(19) United States
(12) Patent Application Publication
(10) Pub. No.: US 2023/0055203 A1
(43) Pub. Date: Feb. 23, 2023

(54) PUCCH CARRIER SWITCH

(71) Applicant: QUALCOMM Incorporated, San Diego, CA (US)

(72) Inventors: Yi HUANG, San Diego, CA (US); Peter GAAL, San Diego, CA (US); Yan ZHOU, San Diego, CA (US)

(21) Appl. No.: 17/658,626

(22) Filed: Apr. 8, 2022

Related U.S. Application Data
(60) Provisional application No. 63/234,665, filed on Aug. 18, 2021.

(51) Int. Cl. H04W 72/04

(52) U.S. Cl. CPC H04W 72/044; H04W 72/0413

(57) ABSTRACT

Methods, apparatuses, and computer-readable medium for improving communication efficiency are provided. An example method may include receiving, from a network entity via MAC-CE, a mapping between a PUCCH spatial relation information and a plurality of PUCCH resources associated with one or more CCs. The example method may further include transmitting a PUCCH to the network entity based on the mapping.

### CROSS REFERENCE TO RELATED APPLICATION(S)

This application claims the benefit of and priority to U.S. Provisional Application Ser. No. 63/234,665, entitled “PUCCH CARRIER SWITCH” and filed on Aug. 18, 2021, which is expressly incorporated by reference herein in its entirety.

### TECHNICAL FIELD

The present disclosure relates generally to communication systems, and more particularly, to wireless communication systems with physical uplink control channel (PUCCH) carrier switch.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive, from a network entity via medium access control (MAC) control element (CE), a mapping between a physical uplink control channel (PUCCH) spatial relation information and a plurality of PUCCH resources associated with one or more component carriers (CCs). The memory and the at least one processor coupled to the memory may be further configured to transmit a PUCCH to the network entity based on the mapping. The method may include receiving, from a network entity via medium access control (MAC) control element (CE), a mapping between a physical uplink control channel (PUCCH) spatial relation information and a plurality of PUCCH resources associated with one or more component carriers (CCs). The method may further include transmitting a PUCCH to the network entity based on the mapping. The computer-readable medium may include instructions that, when executed by an apparatus, cause the apparatus to receive, from a network entity via medium access control (MAC) control element (CE), a mapping between a physical uplink control channel (PUCCH) spatial relation information and a plurality of PUCCH resources associated with one or more component carriers (CCs) and transmit a PUCCH to the network entity based on the mapping.

In another aspect of the disclosure, a method, a computer-readable medium, and an apparatus at a UE are provided. The apparatus may include a memory and at least one processor coupled to the memory. The memory and the at least one processor coupled to the memory may be configured to receive, from a network entity via RRC, a time pattern for transmitting a PUCCH including resources of a secondary cell (SCell). The memory and the at least one processor coupled to the memory may be further configured to receive, from the network entity via MAC-CE, a deactivation of the SCell indicated for transmitting the PUCCH. The memory and the at least one processor coupled to the memory may be further configured to adjust transmission of the PUCCH in the resources of the SCell based on the deactivation of the S Cell. The method may include receiving, from a network entity via RRC, a time pattern for transmitting a PUCCH including resources of a secondary cell (SCell). The method may further include receiving, from the network entity via MAC-CE, a deactivation of the SCell indicated for transmitting the PUCCH. The method may further include adjusting transmission of the PUCCH in the resources of the SCell based on the deactivation of the SCell. The computer-readable medium may include instructions that, when executed by an apparatus, cause the apparatus to receive, from a network entity via RRC, a time pattern for transmitting a PUCCH including resources of a secondary cell (SCell), receive, from the network entity via MAC-CE, a deactivation of the SCell indicated for transmitting the PUCCH, and adjust transmission of the PUCCH in the resources of the SCell based on the deactivation of the SCell.

In another aspect of the disclosure, a method, a computer-readable medium, and an apparatus at a UE are provided. The apparatus may include a memory and at least one processor coupled to the memory. The memory and the at least one processor coupled to the memory may be configured to receive, from a network entity, a configuration of a PUCCH group comprising multiple CCs. The memory and the at least one processor coupled to the memory may be further configured to receive an enablement of a subset of the multiple CCs of the PUCCH group for transmission of a PUCCH. The memory and the at least one processor coupled to the memory may be further configured to receive a downlink control information (DCI) indicating a CC from the PUCCH group for the transmission of the PUCCH in a slot. The memory and the at least one processor coupled to the memory may be further configured to transmit the PUCCH to the network entity in the CC during the slot. The method may include receiving, from a network entity, a configuration of a PUCCH group comprising multiple CCs. The method may further include receiving an enablement of a subset of the multiple CCs of the PUCCH group for transmission of a PUCCH. The method may further include receiving a downlink control information (DCI) indicating a CC from the PUCCH group for the transmission of the PUCCH in a slot. The method may further include transmitting the PUCCH to the network entity in the CC during the slot. The computer-readable medium may include instructions that, when executed by an apparatus, cause the apparatus to receive, from a network entity, a configuration of a PUCCH group comprising multiple CCs. The computer-readable medium may include instructions that, when executed by an apparatus, cause the apparatus to receive an enablement of a subset of the multiple CCs of the PUCCH group for transmission of a PUCCH. The computer-readable medium may include instructions that, when executed by an apparatus, cause the apparatus to receive a downlink control information (DCI) indicating a CC from the PUCCH group for the transmission of the PUCCH in a slot. The computer-readable medium may include instructions that, when executed by an apparatus, cause the apparatus to transmit the PUCCH to the network entity in the CC during the slot.

In another aspect of the disclosure, a method, a computer-readable medium, and an apparatus at a base station are provided. The apparatus may include a memory and at least one processor coupled to the memory. The memory and the at least one processor coupled to the memory may be configured to transmit, to a UE via MAC-CE, a mapping between a PUCCH spatial relation information and a plurality of PUCCH resources associated with one or more CCs. The memory and the at least one processor coupled to the memory may be further configured to receive a PUCCH from the UE based on the mapping. The method may include transmitting, to a UE via MAC-CE, a mapping between a PUCCH spatial relation information and a plurality of PUCCH resources associated with one or more CCs. The method may further include receiving a PUCCH from the UE based on the mapping. The computer-readable medium may include instructions that, when executed by an apparatus, cause the apparatus to transmit, to a UE via MAC-CE, a mapping between a PUCCH spatial relation information and a plurality of PUCCH resources associated with one or more CCs. The computer-readable medium may further include instructions that, when executed by an apparatus, cause the apparatus to receive a PUCCH from the UE based on the mapping.

In another aspect of the disclosure, a method, a computer-readable medium, and an apparatus at a UE are provided. The apparatus may include a memory and at least one processor coupled to the memory. The memory and the at least one processor coupled to the memory may be configured to transmit, for a UE via RRC, a time pattern for transmitting a PUCCH including resources of a SCell. The memory and the at least one processor coupled to the memory may be further configured to transmit, for the UE via MAC-CE, a deactivation of the SCell indicated for transmitting the PUCCH. The memory and the at least one processor coupled to the memory may be further configured to receive an adjusted transmission of the PUCCH in the resources of the SCell based on the deactivation of the SCell. The method may include transmitting, for a UE via RRC, a time pattern for transmitting a PUCCH including resources of a SCell. The method may include transmitting, for the UE via MAC-CE, a deactivation of the SCell indicated for transmitting the PUCCH. The method may include receiving an adjusted transmission of the PUCCH in the resources of the SCell based on the deactivation of the SCell. The computer-readable medium may include instructions that, when executed by an apparatus, cause the apparatus to transmit, for a UE via RRC, a time pattern for transmitting a PUCCH including resources of a SCell. The computer-readable medium may further include instructions that, when executed by an apparatus, cause the apparatus to transmit, for the UE via MAC-CE, a deactivation of the SCell indicated for transmitting the PUCCH. The computer-readable medium may further include instructions that, when executed by an apparatus, cause the apparatus to receive an adjusted transmission of the PUCCH in the resources of the SCell based on the deactivation of the SCell.

In another aspect of the disclosure, a method, a computer-readable medium, and an apparatus at a UE are provided. The apparatus may include a memory and at least one processor coupled to the memory. The memory and the at least one processor coupled to the memory may be configured to transmit, to a UE, a configuration of a PUCCH group comprising multiple CCs. The memory and the at least one processor coupled to the memory may be further configured to transmit an enablement of a subset of the multiple CCs of the PUCCH group for transmission of a PUCCH. The memory and the at least one processor coupled to the memory may be further configured to transmit a DCI indicating a CC from the PUCCH group for the transmission of the PUCCH in a slot. The memory and the at least one processor coupled to the memory may be further configured to receive the PUCCH from the UE in the CC during the slot. The method may include transmitting, to a UE, a configuration of a PUCCH group comprising multiple CCs. The method may include transmitting an enablement of a subset of the multiple CCs of the PUCCH group for transmission of a PUCCH. The method may include transmitting a DCI indicating a CC from the PUCCH group for the transmission of the PUCCH in a slot. The method may include receiving the PUCCH from the UE in the CC during the slot. The computer-readable medium may include instructions that, when executed by an apparatus, cause the apparatus to transmit, to a UE, a configuration of a PUCCH group comprising multiple CCs. The computer-readable medium may include instructions that, when executed by an apparatus, cause the apparatus to transmit an enablement of a subset of the multiple CCs of the PUCCH group for transmission of a PUCCH. The computer-readable medium may include instructions that, when executed by an apparatus, cause the apparatus to transmit a DCI indicating a CC from the PUCCH group for the transmission of the PUCCH in a slot. The computer-readable medium may include instructions that, when executed by an apparatus, cause the apparatus to receive the PUCCH from the UE in the CC during the slot.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of PUCCH groups.

FIG. 5 is a diagram illustrating example PUCCH switch and repetitions.

FIG. 6 is a diagram illustrating example mapping between PUCCH spatial relation information and PUCCH resources.

FIG. 7 is a diagram illustrating MAC-CE that may set PUCCH spatial relation information for PUCCH resources.

FIG. 8 is a diagram illustrating example mapping between PUCCH spatial relation information and PUCCH resources.

FIG. 9 is a diagram illustrating MAC-CE that may set PUCCH spatial relation information for PUCCH resources.

FIG. 10 is a diagram illustrating example mapping between PUCCH spatial relation information and PUCCH resources and MAC-CE that may set PUCCH spatial relation information for PUCCH resources.

FIG. 11 is a diagram illustrating example mapping between PUCCH spatial relation information and PUCCH resources and MAC-CE that may set PUCCH spatial relation information for PUCCH resources.

FIG. 12 is a diagram illustrating example time pattern with SCell deactivation.

FIG. 13 is a diagram illustrating an example of PUCCH groups.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a flowchart of a method of wireless communication.

FIG. 20 is a diagram illustrating an example of a hardware implementation for an example apparatus.

FIG. 21 is a diagram illustrating an example of a hardware implementation for an example apparatus.

FIG. 22 shows a diagram illustrating an example disaggregated base station architecture.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

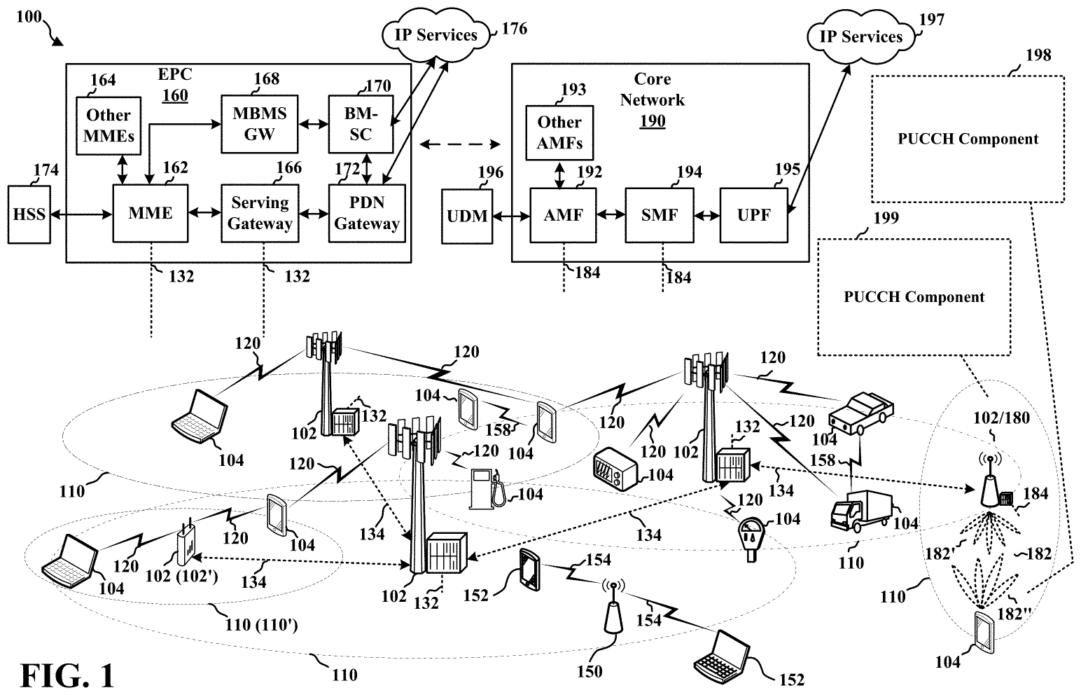

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some network entities or base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The network entity may be a network node. A network node may be implemented as an aggregated base station, as a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the network entity, e.g., 102, belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a PUCCH component 198. In some aspects, the PUCCH component 198 may be configured to receive, from a network entity via MAC-CE, a mapping between a PUCCH spatial relation information and a plurality of PUCCH resources associated with one or more CCs. In some aspects, the PUCCH component 198 may be further configured to transmit a PUCCH to the network entity based on the mapping.

In certain aspects, the base station 180 may include a PUCCH component 199. In some aspects, the PUCCH component 199 may be configured to transmit, to a UE via MAC-CE, a mapping between a PUCCH spatial relation information and a plurality of PUCCH resources associated with one or more CCs. In some aspects, the PUCCH component 199 may be further configured to receive a PUCCH from the UE based on the mapping.

Although the following description may be focused on 5G NR, the concepts described herein may be applicable to other similar areas, such as LTE, LTE-A, CDMA, GSM, and other wireless technologies.

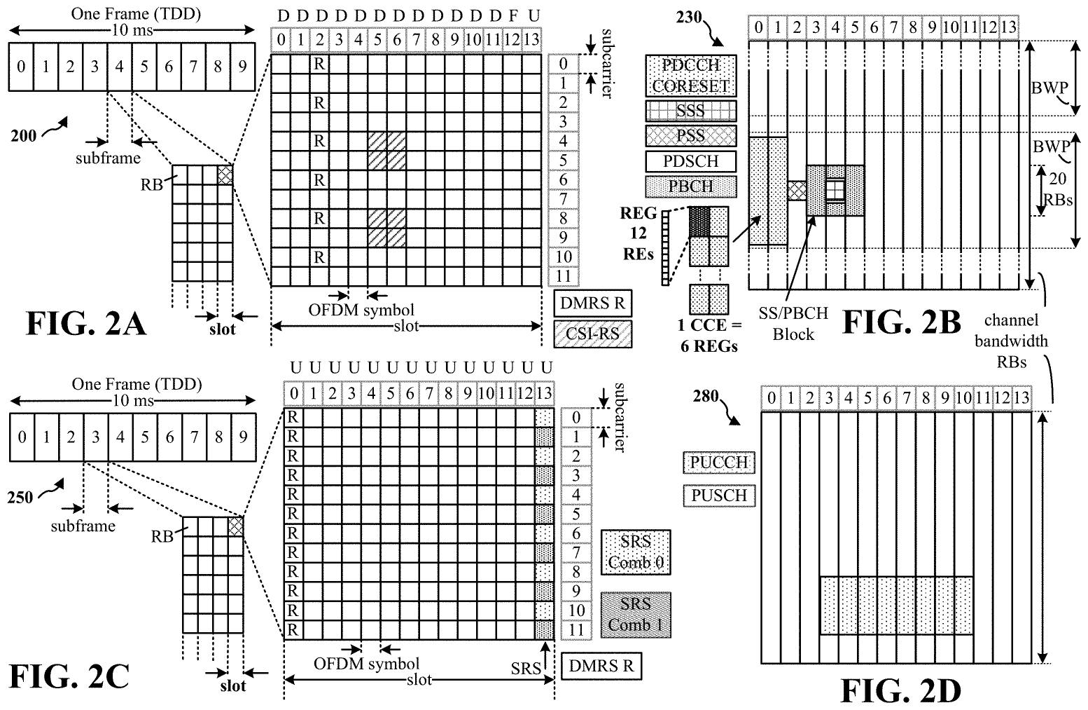

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

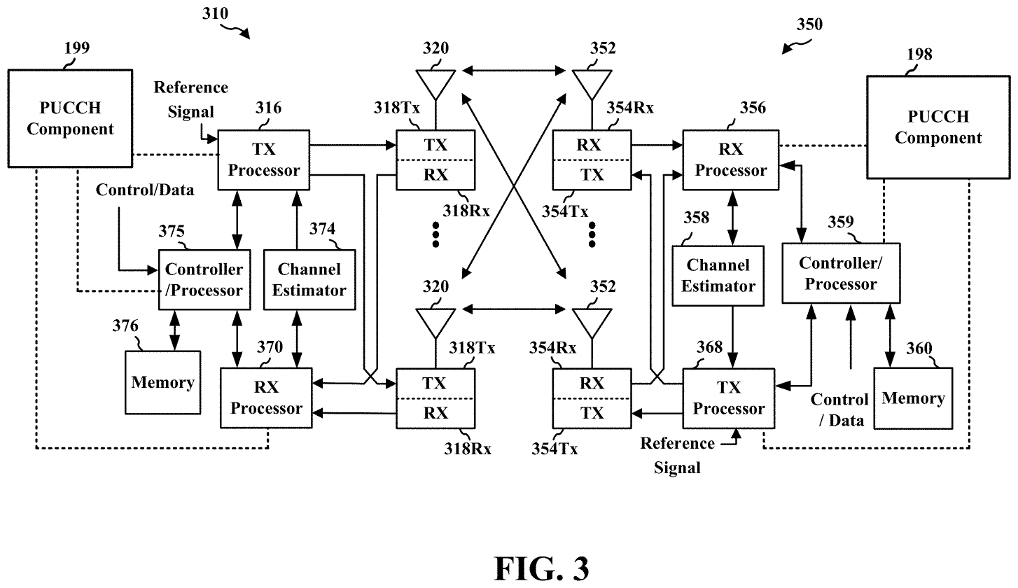

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with PUCCH component 198 of FIG. 1.

At least one of the TX processor 316, the RX processor 370, and the controller/processor 375 may be configured to perform aspects in connection with PUCCH component 198 of FIG. 1.

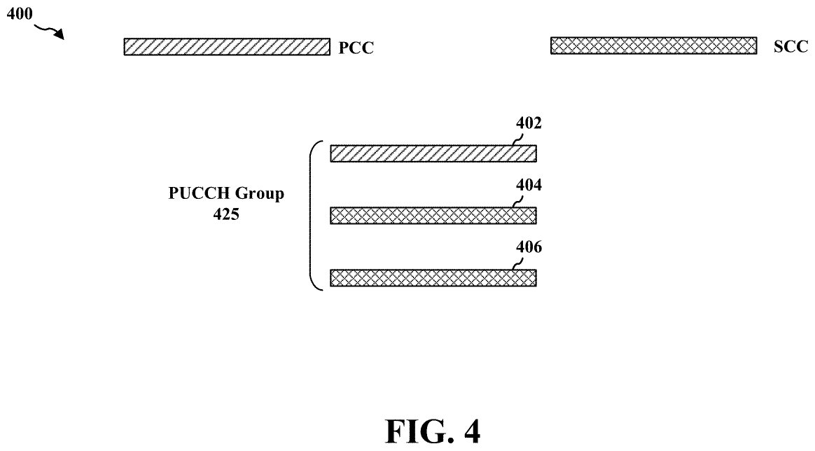

Carrier aggregation is a feature in some wireless communication systems that may combine multiple frequency bands to offer additional bandwidth, which may result in faster data speeds. In some wireless communication systems that provide uplink carrier aggregation, a PUCCH may be transmitted on a primary cell (Pcell) in a PUCCH group. FIG. 4 is a diagram 400 illustrating examples of PUCCH groups. As illustrated in FIG. 4, a PUCCH in a PUCCH group 425 may be transmitted on a primary cell 402. If a PCC is a TDD carrier, the PUCCH may involve a delay due to a TDD pattern of uplink (U), downlink (D), special (S) slots. As an example, the PUCCH transmission may not be available in a D slot of the TDD pattern. The PUCCH group 425 may further include a secondary cell 404 and a secondary cell 406 that are not for transmitting PUCCH, e.g., different than the PUCCH-SCell.

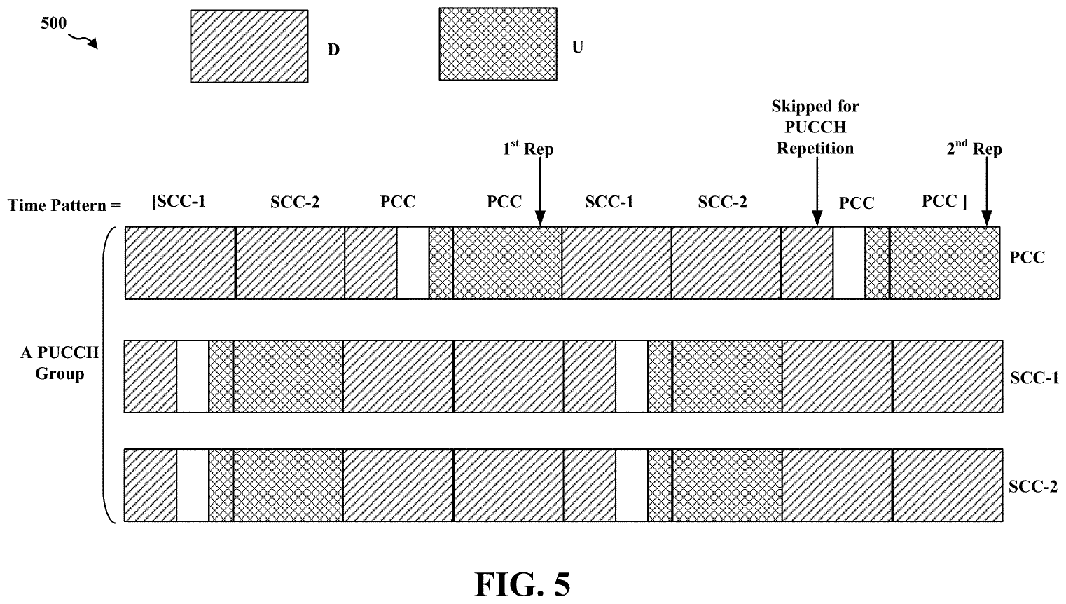

In some other wireless communication systems, that provide uplink carrier aggregation, a PUCCH may be transmitted on a primary cell (Pcell) or a PUCCH secondary cell (PUCCH-SCell) in a PUCCH group. In such communication systems, PUCCH switching among different component carriers (CCs) may be allowed. For example, a base station may indicate which CC the UE is to use to transmit a PUCCH in a slot. In TDD UL CA, each CC in a PUCCH group may be a TDD carrier. The base station may configure the TDD pattern in a staggered or complementary fashion in the time domain. The base station may indicate to the UE a particular CC for the UE to transmit PUCCH in a slot. The base station may transmit the indication in a field in downlink control information (DCI) (which may be a dynamic indication) and/or a radio resource control (RRC) configured time pattern (which may be a semi-static indication). A dynamic indication in DCI may be used for acknowledgment/negative acknowledgment (A/N) for dynamic scheduled PDSCH. An RRC configured time pattern may be used for A/N for semi-persistent scheduling (SPS) PDSCH. FIG. 5 is a diagram 500 illustrating example PUCCH switch and repetitions. FIG. 5 illustrates a time pattern for the transmission of PUCCH on the CCs of the PUCCH group. In FIG. 5, the time pattern corresponds SCC-1, SCC-2, PCC, PCC, SCC-1, SCC-2, PCC, PCC over a period of eight slots. As illustrated in FIG. 5, PUCCH may be repeated on primary cells and each slot may include one PUCCH repetition. For example, for a PUCCH with two repetitions and each repetition with a duration of 14 OFDM symbols, a base station may indicate a starting slot for a first repetition. For subsequent repetitions, the UE may sweep subsequent uplink slots on a primary component carrier (PCC), and transmit the PUCCH repetition on the slots having enough uplink OFDM symbols to accommodate one PUCCH repetition.

A PUCCH transmission may be associated with a spatial setting (which may be otherwise referred to as “spatial information” or “spatial relation information”), such as a spatial setting provided by a PUCCH spatial relation parameter (e.g., which may be referred to as “PUCCH-spatialRelationInfo”). For example, a UE may be configured with a single PUCCH-spatialRelationInfo and may use the configured PUCCH-spatialRelationInfo for a PUCCH transmission. In some other examples, a UE may be configured with multiple PUCCH-spatialRelationInfo, and may determine a spatial setting for the PUCCH transmission based on the multiple PUCCH-spatialRelationInfo. The UE may also apply a corresponding setting for a spatial domain filter to transmit PUCCH. For example, the PUCCH may be transmitted in a first slot after the slot where the UE would transmit a PUCCH with HARQ-ACK information with an ACK value corresponding to a PDSCH reception providing the PUCCH-spatialRelationInfo and is the SCS configuration for the PUCCH.

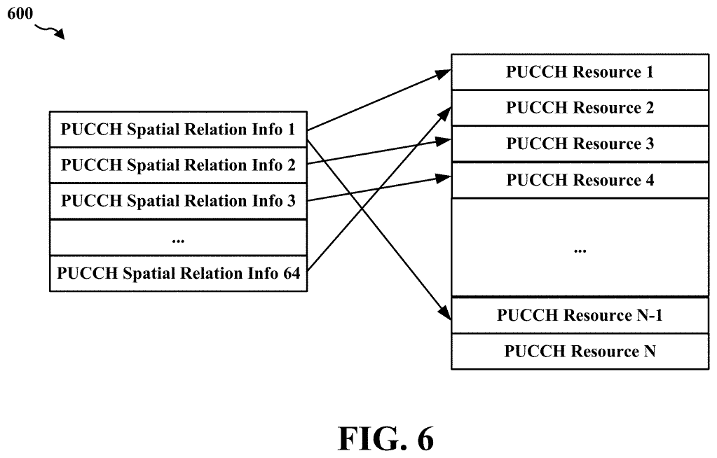

In some wireless communication systems, the PUCCH-spatialRelationInfo may be configured per (UL) bandwidth part (BWP) for PCCs but not for SCCs. For example, up to X PUCCH-spatialRelationInfo parameter (such as X=64), may be configured for a UL BWP. In some aspects, MAC-CE may map one PUCCH-spatialRelationinfo for each PUCCH resource. In some aspects, one PUCCH-spatialRelationinfo may map to multiple PUCCH resources, while one PUCCH resource may map to one PUCCH-spatialRelationinfo. FIG. 6 is a diagram 600 illustrating example mapping between PUCCH spatial relation information and PUCCH resources. As illustrated in FIG. 6, each PUCCH-spatialRelationinfo may map to multiple PUCCH resources and one PUCCH resource may map to one PUCCH-spatialRelationinfo. In some aspects, one MAC-CE may set PUCCH-spatialRelationinfo for a group of PUCCH resources.

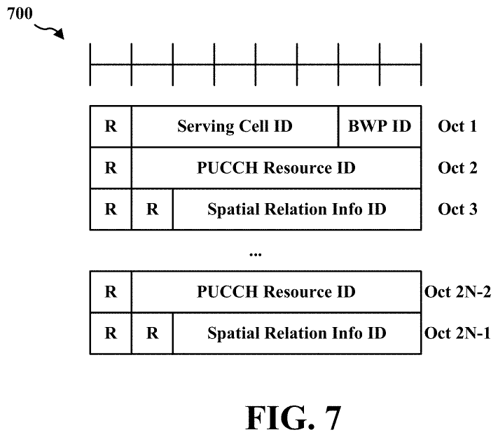

FIG. 7 is a diagram 700 illustrating MAC-CE that may set PUCCH spatial relation information for PUCCH resources. As illustrated in FIG. 7, the MAC-CE may include a serving cell identifier (ID). The serving cell ID may indicate the identity of the serving cell for which the MAC-CE applies. The MAC-CE may further include a BWP ID. The BWP ID may indicate a UL BWP for which the MAC CE applies as the codepoint of the DCI bandwidth part indicator field. The MAC-CE may further include a PUCCH resource ID. The PUCCH resource ID may include an identifier of the PUCCH resource ID identified by a parameter PUCCH-ResourceId, which may be activated with a spatial relation indicated by a Spatial Relation Info ID field in subsequent octet (Oct). If the indicated PUCCH resource ID is included in a PUCCH resource group, such as a PUCCH resource group configured by a resourceGroupToAddModList parameter of the indicated UL BWP, in some aspects, no other PUCCH Resources within the same PUCCH resource group may be indicated in the MAC-CE, and the MAC-CE may apply to all the PUCCH Resources in the PUCCH resource group. The MAC-CE may further include a spatial relation info ID that may include an identifier of the PUCCH spatial relation info in a PUCCH configuration in which the PUCCH resource ID may be configured. The MAC-CE may further include reserved bits indicated by R.

In some wireless communication systems, a PUCCH-spatialRelationInfo parameter (such as represented by a Spatial Relation Info ID field) is configured per (UL) BWP for every PUCCH cell (e.g., primary or secondary cell enabled with or configured for transmitting PUCCH). For example, up to X PUCCH-SpatialRelationInfo parameter (such as X=64), may be configured for a UL BWP.

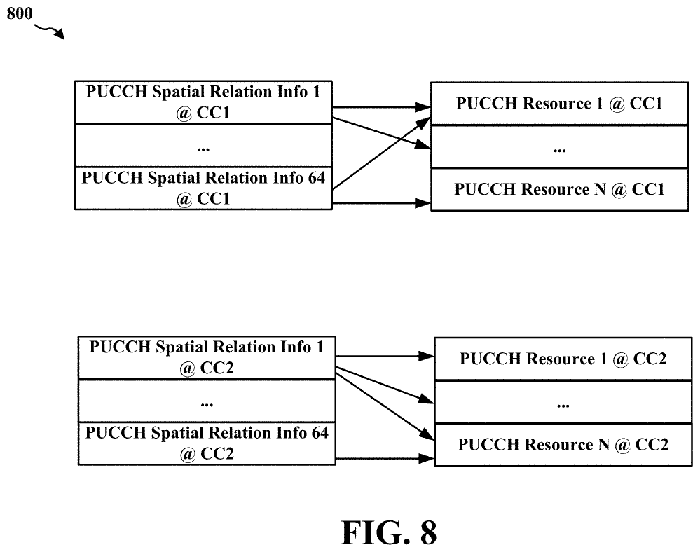

FIG. 8 is a diagram 800 illustrating example mapping between PUCCH spatial relation information and PUCCH resources. As illustrated in FIG. 8, in some aspects, the MAC-CE may map at least one PUCCH-spatialRelationinfo for each PUCCH resource. With multi-transmission reception point (TRP) at a base station, multiple PUCCH spatialRelationInfo associated with different TRPs may be mapped to a PUCCH resource. One MAC-CE may set PUCCH-spatialRelationinfo for a group of PUCCH resources across multiple CCs. The mapping from spatialRelation ID to PUCCH resource ID may be different on different CCs.

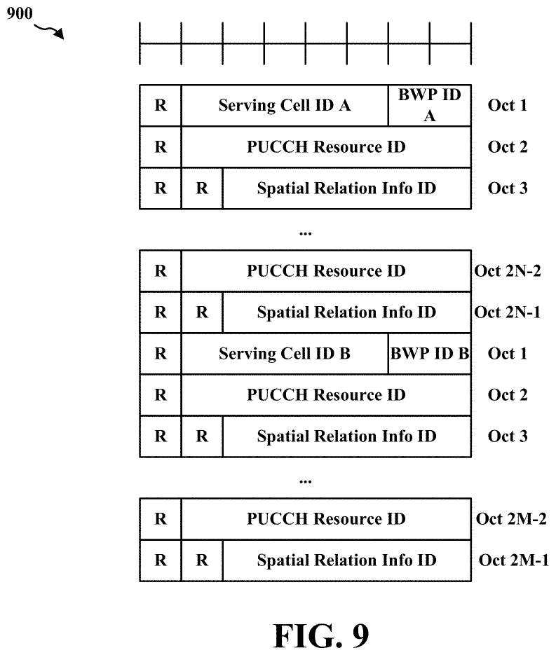

FIG. 9 is a diagram 900 illustrating MAC-CE that may set PUCCH spatial relation information for PUCCH resources. As illustrated in FIG. 9, the MAC-CE may include serving cell ID and associated spatial relation information and associated PUCCH resource ID for more than one serving cell.

Aspects provided herein may reduce signaling overhead in MAC-CE by providing more efficient mapping in MAC-CE, resulting in more efficient communication with more bandwidth to carry data.

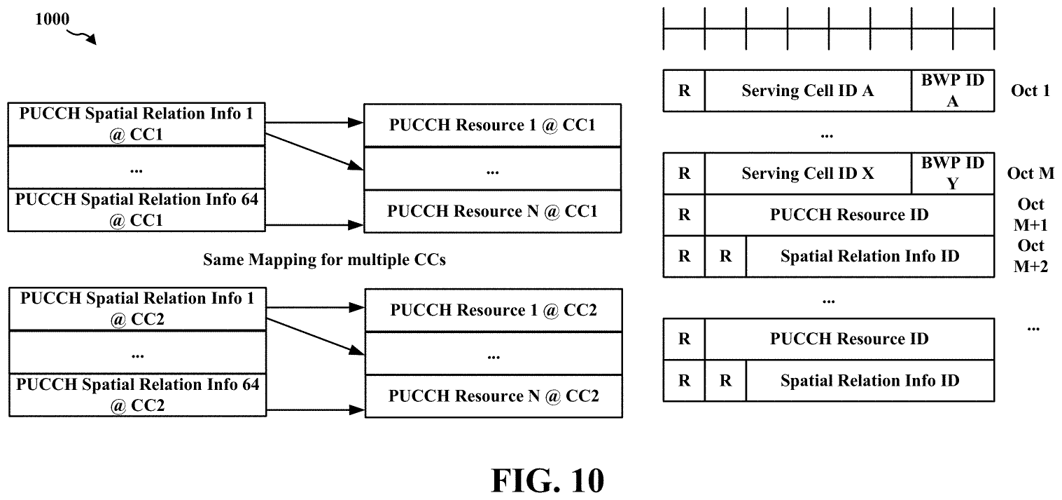

FIG. 10 is a diagram 1000 illustrating example mapping between PUCCH spatial relation information and PUCCH resources and MAC-CE that may set PUCCH spatial relation information for PUCCH resources. As illustrated in FIG. 10, in some aspects, a MAC-CE may indicate a mapping between a spatialRelation ID and a PUCCH resource ID, and the same mapping may apply to a plurality of CCs (configured by a base station via radio resource control (RRC)). For example, a same mapping may be applied for CC1 and CC2 as illustrated in FIG. 10. In some aspects, the mapping may apply to all CCs that can transmit PUCCH. By using a same mapping across a plurality of CCs, the MAC-CE may be able to avoid including repeated PUCCH resource ID and spatial relation ID, resulting in less overhead.

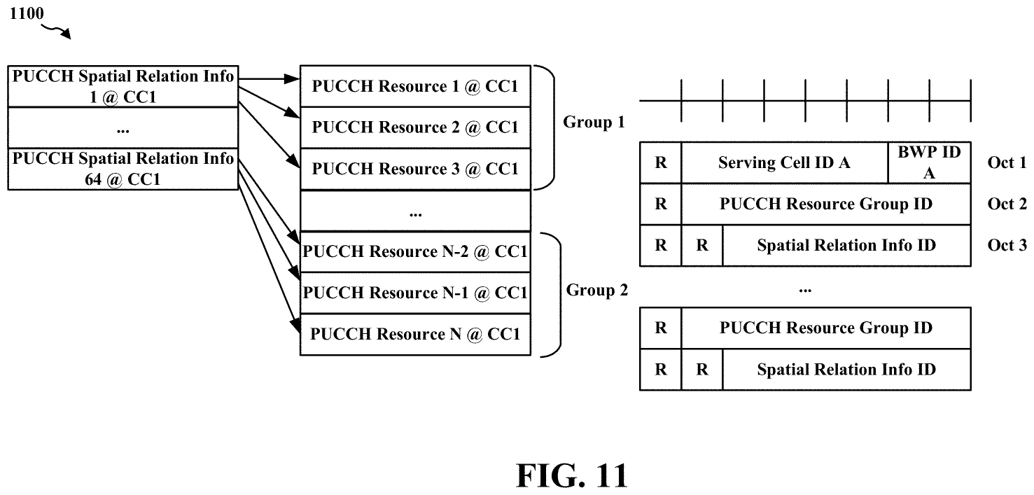

In some aspects, the MAC-CE may indicate a mapping between a spatialRelation ID to a group of PUCCH resources. FIG. 11 is a diagram 1100 illustrating example mapping between PUCCH spatial relation information and PUCCH resources and MAC-CE that may set PUCCH spatial relation information for PUCCH resources. As illustrated in FIG. 11, the MAC-CE may indicate a mapping between a spatialRelation ID to a group of PUCCH resources. In some aspects, group ID may be defined to be associated with one or more PUCCH IDs, and the MAC-CE may provide mapping between spatialRelation ID and PUCCH group ID. Alternatively, the MAC-CE may provide mapping between spatialRelation ID and PUCCH ID and the mapping may be propagated to one or more other PUCCH IDs within a same group.

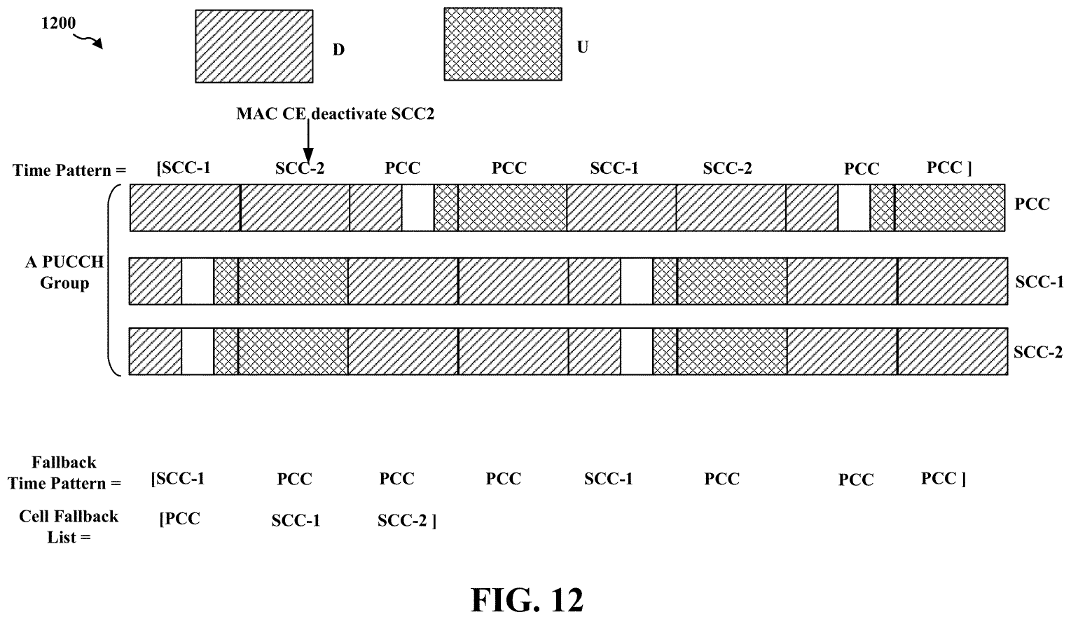

FIG. 12 is a diagram 1200 illustrating example time pattern with SCell deactivation. As one example, the time pattern may be configured semi-statically via RRC (e.g., such as the RRC configuring the mapping described in connection with FIGS. 10 and 11). SCell activation/deactivation may be performed dynamically via MAC-CE. As illustrated in FIG. 12, a cell (such as a SCell) that may be indicated to transmit PUCCH by the time pattern may be deactivated by a MAC-CE. In some aspects, the UE may avoid using, e.g., not transmit PUCCH in, a slot associated with the deactivated SCell in the time pattern to transmit PUCCH, which may result in unused resources in the slot(s) corresponding to a deactivated SCell. In some aspects, for semi-static PUCCH cell switching, if the alternative PUCCH cell (e.g., PUCCH SCell) is deactivated or the alternative PUCCH cell is dormant, the UE may not apply time-domain pattern and the UCI may be transmitted on PCell, primary secondary cell (SPCell), or PUCCH SCell. Some aspects provided herein may more efficiently utilize resources by defining fallback behaviors. In some aspects, a base station may configure a fallback time pattern for the UE. The UE may be able to refer to the fallback time pattern if a cell in the nominal time pattern is deactivated. UE may refer back to the nominal time pattern if the cell is reactivated. By providing a fallback pattern, the UE may be able to use the slot associated with a deactivated SCell by switching to another cell, resulting in more efficient usage of resources. In some aspects, the base station may define a cell fallback list with a cell ordering (which may be otherwise referred to as “cell priority”). For example, the base station may define a cell fallback list of [PCC, SCC-1, SCC-2]. For one slot, if one specified cell in the time pattern is deactivated, the UE may check other cells following the defined ordering, and fallback to the first cell (e.g., cell with the highest priority) in the fallback list. For example, based on the cell fallback list of [PCC, SCC-1, SCC-2], the UE may fall back to the PCC if SCC-2 is deactivated.

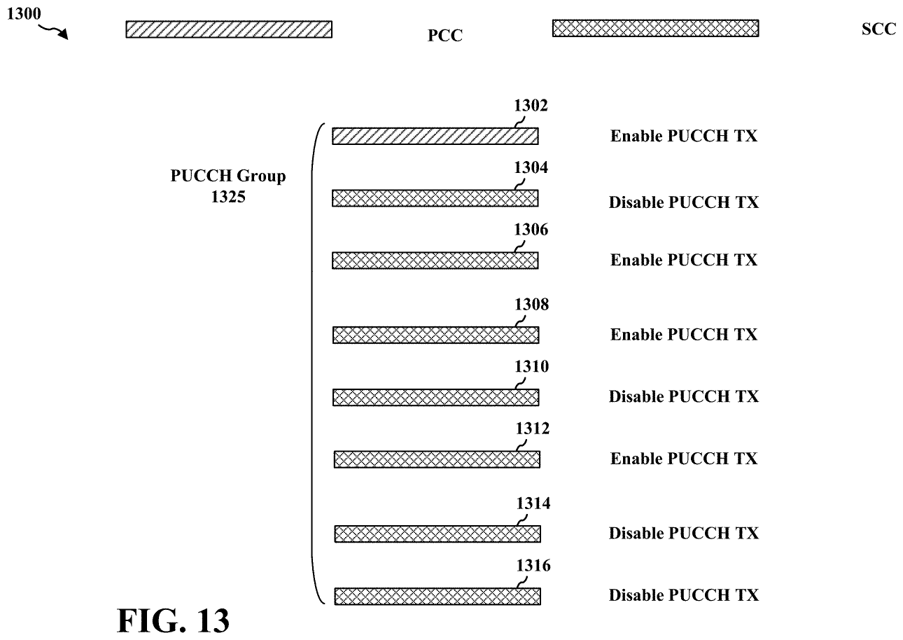

In some wireless communication systems, a DCI may be used for indicating which CC may be used for transmitting PUCCH in a slot. Therefore, a base station may use the DCI to enable a subset of cells in a PUCCH group to transmit PUCCH. FIG. 13 is a diagram 1300 illustrating an example of PUCCH groups. As illustrated in FIG. 13, within a PUCCH group 1325, a PCC 1302, an SCC 1306, an SCC 1308, and an SCC 1312 may be enabled by a DCI for transmitting PUCCH. A UE may use one of the PCC 1302, the SCC 1306, the SCC 1308, or the SCC 1312 to transmit a PUCCH. An SCC 1304, an SCC 1310, an SCC 1314, and an SCC 1316 may be disabled by a DCI for transmitting PUCCH. To represent each CC in the example total of 8 CCs, some wireless communications may use three bits in a codepoint. Aspects provided herein may reduce signaling overhead in DCI by reducing the number of bits therein representing CCs. For example, a codepoint may map to the subset of cells that are enabled for PUCCH transmission but not map to the subset of cells that are configured in the PUCCH group yet are disabled for PUCCH transmission. By not mapping to the subset of cells in the PUCCH group that are disabled for PUCCH transmission, signaling overhead in a codepoint of the DCI may be reduced. A two bit field may provide any of the following codepoints {00, 01, 10, 11}. In the example, in FIG. 13, “00” may refer to the PCC 1302, “01” may refer to SCC-2 1306, “10” may refer to SCC-3 1308, and “11” may refer to SCC-5 1312. The four options of the codepoint may refer to, or be interpreted based on, the subset of enabled cells rather than to the entire set of cells in the PUCCH group.

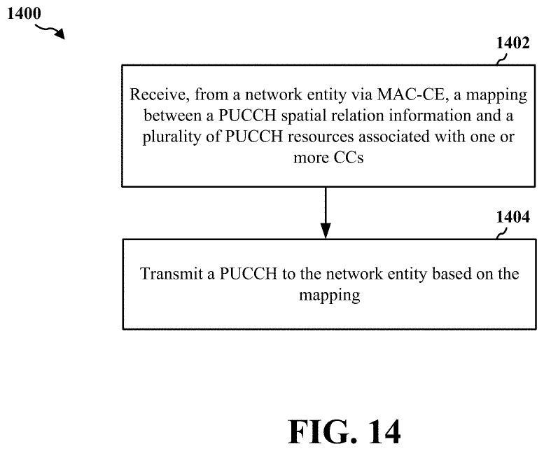

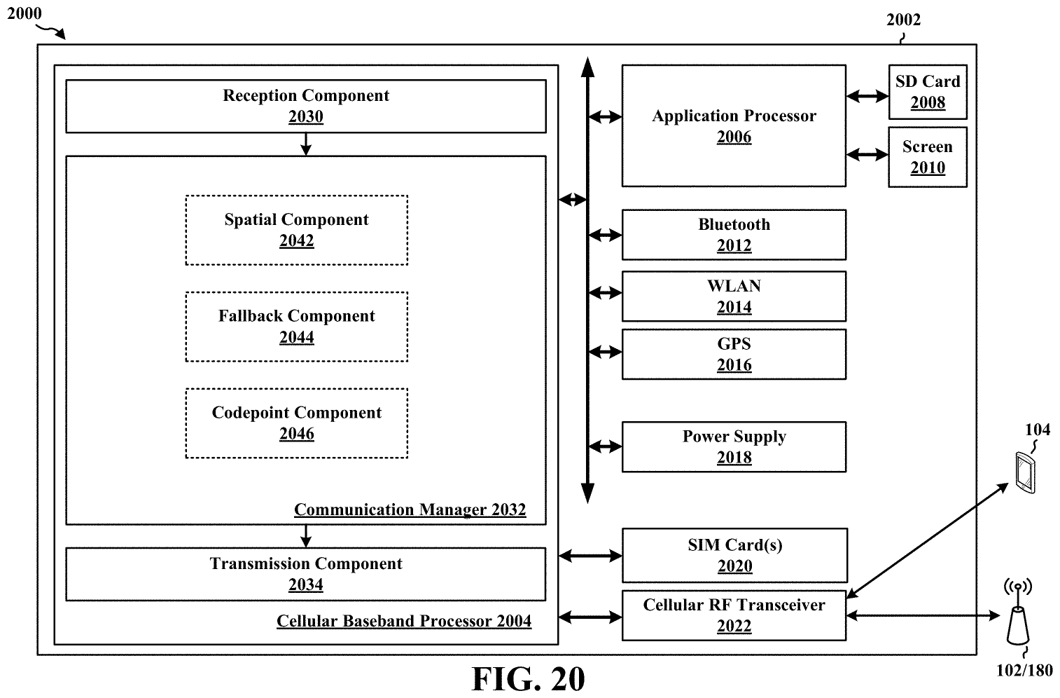

FIG. 14 is a flowchart 1400 of a method of wireless communication. The method may be performed by a UE (e.g., the UE 104 of FIG. 1; the apparatus 2002 of FIG. 20). The method may be used for reducing signaling overhead in MAC-CE.

At 1402, the UE may receive, from a network entity (e.g. a base station or a component of a base station) via MAC-CE, a mapping between a PUCCH spatial relation information and a plurality of PUCCH resources associated with one or more CCs. For example, a UE may receive, from a network entity (e.g. a base station) via MAC-CE, a mapping between a PUCCH spatial relation information and a plurality of PUCCH resources associated with one or more CCs, such as described in connection with FIGS. 10-11. In some aspects, 1402 may be performed by spatial component 2042 of FIG. 20. In some aspects, each of the plurality of PUCCH resources is associated with a same PUCCH resource ID, and each of the plurality of PUCCH resources is associated with a different CC of the one or more CCs. In some aspects, a plurality of CCs is configured by the network entity (e.g., the base station) via RRC. In some aspects, the plurality of CCs may include the one or more CCs and may also include additional CCs. In some aspects, the plurality of PUCCH resources is associated with more than one PUCCH resource ID, and the more than one PUCCH resource ID are associated with at least one group. In some aspects, each group of the at least one group is associated with one CC of the one or more CCs. In some aspects, the at least one group may be defined groups associated with the one or more CCs.

At 1404, the UE may transmit a PUCCH to the network entity (e.g., the base station) based on the mapping. For example, the UE may transmit the PUCCH after determining a PUCCH setting based on the PUCCH spatial relation information and the mapping. In some aspects, 1404 may be performed by spatial component 2042 of FIG. 20.

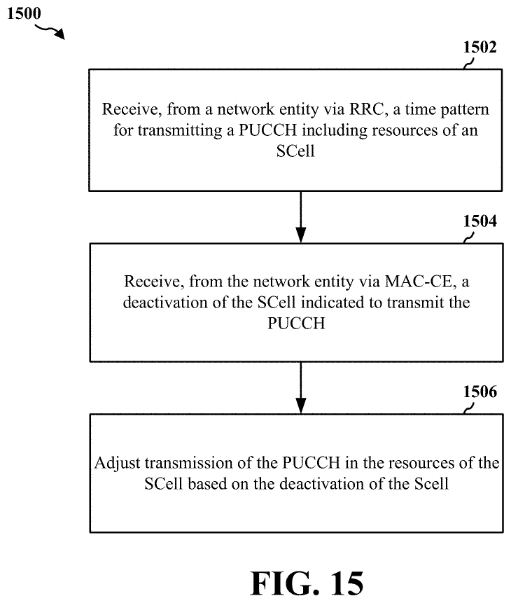

FIG. 15 is a flowchart 1500 of a method of wireless communication. The method may be performed by a UE (e.g., the UE 104 of FIG. 1; the apparatus 2002 of FIG. 20). The method may be used for more efficiently using resources upon deactivation of a SCell for transmitting a PUCCH.

At 1502, the UE may receive, from a network entity (e.g., a base station or a component of a base station) via RRC, a time pattern for transmitting a PUCCH including resources of a SCell. For example, as illustrated in FIG. 12, a UE may receive, from a network entity (e.g., a base station) via RRC, a time pattern for transmitting a PUCCH including resources of a SCell. In some aspects, 1502 may be performed by fallback component 2044 of FIG. 20.

At 1504, the UE may receive, from the network entity (e.g., a base station) via MAC-CE, a deactivation of the SCell indicated for transmitting the PUCCH. For example, as illustrated in FIG. 12, a UE may receive, from the network entity via MAC-CE, a deactivation of the SCell indicated for transmitting the PUCCH. In some aspects, 1504 may be performed by fallback component 2044 of FIG. 20.

At 1506, the UE may adjust transmission of the PUCCH in the resources of the SCell based on the deactivation of the SCell. For example, as illustrated in FIG. 12, a UE may adjust transmission of the PUCCH in the resources of the SCell based on the deactivation of the SCell. In some aspects, 1506 may be performed by fallback component 2044 of FIG. 20. In some aspects, to adjust the transmission of the PUCCH in the resources of the SCell, the UE may skip the transmission of the PUCCH in the resources based on the deactivation of the SCell. In some aspects, adjustment of the transmission of the PUCCH in the resources of the SCell includes transmission of the PUCCH to the network entity based on a fallback pattern. In some aspects, the UE may receive a fallback pattern configuration from the network entity. In some aspects, the fallback pattern comprises a fallback time pattern. A fallback time pattern may be a time pattern that the UE may use based on the deactivation of the SCell. In some aspects, the fallback pattern defines a cell fallback list indicating one or more cells, and the UE may use one cell of the one or more cells to transmit the PUCCH.

In some aspects, the UE may further receive, from the network entity (e.g., a base station) via MAC-CE, a reactivation of the SCell indicated for transmitting the PUCCH. The UE may transmit the PUCCH based on the time pattern after the reactivation of the SCell.

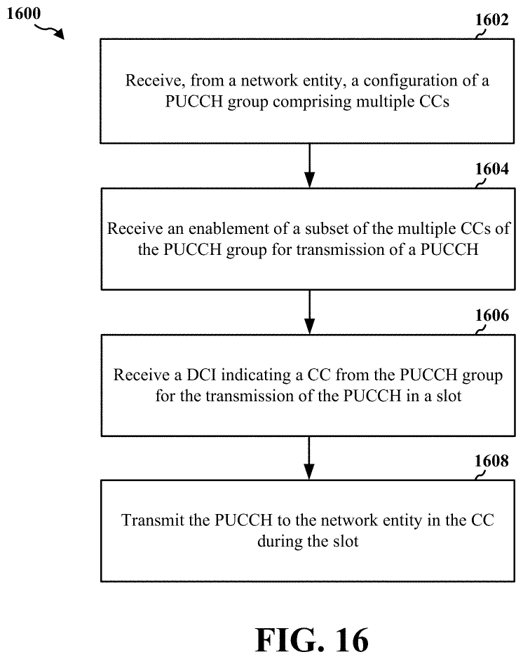

FIG. 16 is a flowchart 1600 of a method of wireless communication. The method may be performed by a UE (e.g., the UE 104 of FIG. 1; the apparatus 2002 of FIG. 20). The method may be used for reducing signaling overhead in DCI.

At 1602, the UE may receive, from a network entity (e.g., a base station or a component of a base station), a configuration of a PUCCH group comprising multiple CCs. For example, as illustrated in FIG. 13, a UE may receive, from a network entity, a configuration of a PUCCH group 1325 comprising multiple CCs. In some aspects, 1602 may be performed by the codepoint component 2046 of FIG. 20.

At 1604, the UE may receive an enablement of a subset of the multiple CCs of the PUCCH group for transmission of a PUCCH. For example, as illustrated in FIG. 13, a UE may receive an enablement of a subset of the multiple CCs (including PCC 1302 and SCC 1306, 1308, and 1312 of FIG. 13) of the PUCCH group for transmission of a PUCCH. In some aspects, 1604 may be performed by the codepoint component 2046 of FIG. 20.

At 1606, the UE may receive a DCI indicating a CC from the PUCCH group for the transmission of the PUCCH in a slot. For example, the UE may receive a DCI indicating a CC from the PUCCH group for the transmission of the PUCCH in a slot (such as one of PCC 1302 and SCC 1306, 1308, and 1312 of FIG. 13). In some aspects, 1606 may be performed by the codepoint component 2046 of FIG. 20. In some aspects, the DCI indicates the CC from the subset of the multiple CCs of the PUCCH group that are enabled. In some aspects, the DCI comprises a codepoint mapped to one of the multiple CCs of the PUCCH group. In some aspects, the DCI comprises a codepoint mapped to one cell within the subset of cells enabled for the transmission of the PUCCH.

At 1608, the UE may transmit the PUCCH to the network entity (e.g., a base station or a component of a base station) in the CC during the slot. For example, as illustrated in FIG. 13, a UE may transmit the PUCCH to the network entity in the CC (such as one of PCC 1302 and SCC 1306, 1308, and 1312 of FIG. 13) during the slot. In some aspects, 1608 may be performed by the codepoint component 2046 of FIG. 20.

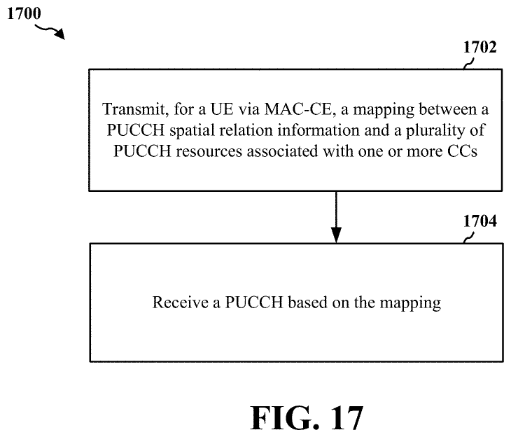

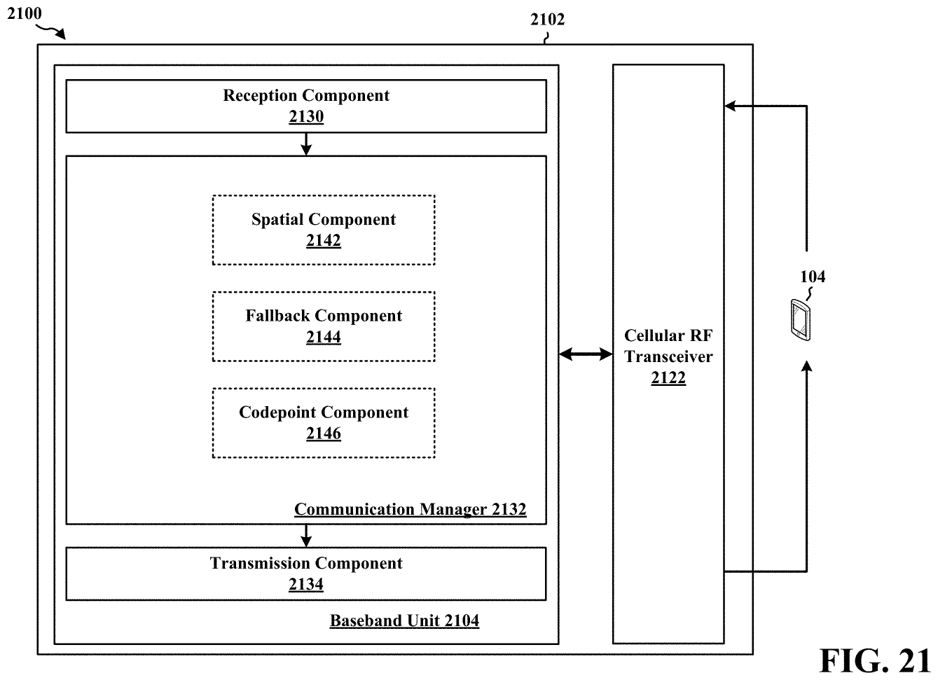

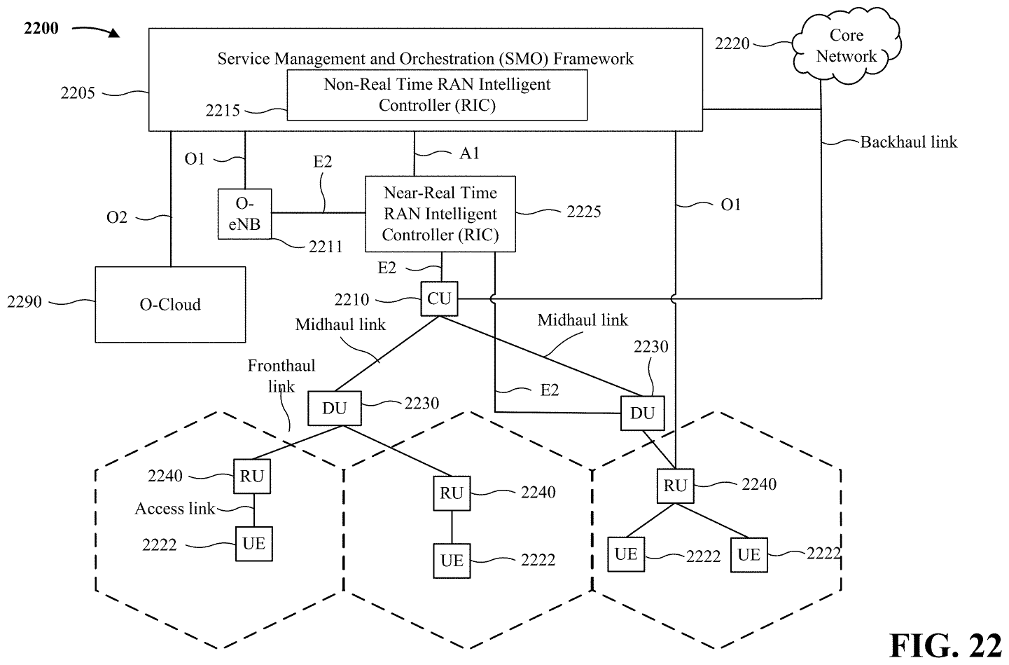

FIG. 17 is a flowchart 1700 of a method of wireless communication. The method may be performed by a network entity, such as a base station or a component of a base station (e.g., the base station 180 of FIG. 1, 310 of FIG. 3; the CU 2210, DU 2230 and/or RU 2240 of FIG. 22; the apparatus 2102 of FIG. 21). The method may be used for reducing signaling overhead in MAC-CE.

At 1702, the network entity (e.g., base station or component of a base station) may transmit, to a UE via MAC-CE, a mapping between a PUCCH spatial relation information and a plurality of PUCCH resources associated with one or more CCs. For example, the network entity (e.g., base station) may transmit, to a UE via MAC-CE, a mapping between a PUCCH spatial relation information and a plurality of PUCCH resources associated with one or more CCs, such as described in connection with FIGS. 10-11. In some aspects, 1702 may be performed by spatial component 2142 of FIG. 21. In some aspects, each of the plurality of PUCCH resources is associated with a same PUCCH resource ID, and each of the plurality of PUCCH resources is associated with a different CC of the one or more CCs. In some aspects, a plurality of CCs is configured by the network entity via RRC. In some aspects, the plurality of CCs may include the one or more CCs and may also include additional CCs. In some aspects, the plurality of PUCCH resources is associated with more than one PUCCH resource ID, and the more than one PUCCH resource ID are associated with at least one group. In some aspects, each group of the at least one group is associated with one CC of the one or more CCs. In some aspects, the at least one group may be defined groups associated with the one or more CCs.

At 1704, the network entity (e.g., base station or component of a base station) may receive a PUCCH from the UE based on the mapping. For example, the UE may transmit the PUCCH after determining a PUCCH setting based on the PUCCH spatial relation information and the mapping. In some aspects, 1704 may be performed by spatial component 2142 of FIG. 21.

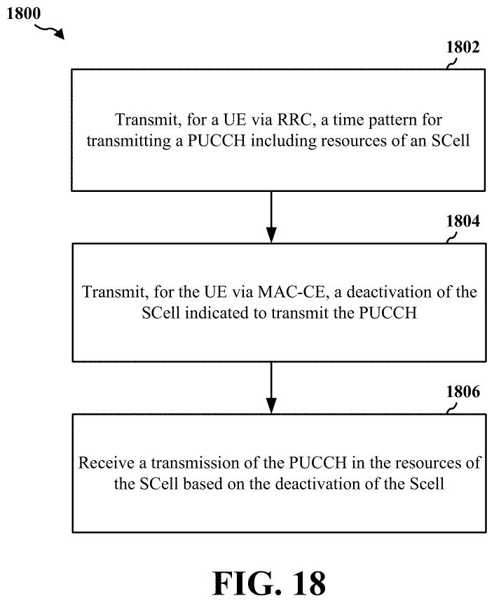

FIG. 18 is a flowchart 1800 of a method of wireless communication. The method may be performed by a network entity, such as a base station (e.g., the base station 180 of FIG. 1, 310 of FIG. 3; the CU 2210, DU 2230 and/or RU 2240 of FIG. 22; the apparatus 2102 of FIG. 21). The method may be used for more efficiently using resources upon deactivation of a SCell for transmitting a PUCCH.

At 1802, the network entity (e.g., base station or component of a base station) may transmit, to a UE via RRC, a time pattern for transmitting a PUCCH including resources of a SCell. For example, as illustrated in FIG. 12, a network entity (e.g., base station) may transmit, to a UE via RRC, a time pattern for transmitting a PUCCH including resources of a SCell. In some aspects, 1802 may be performed by fallback component 2144 of FIG. 21.

At 1804, the network entity (e.g., base station or component of a base station) may transmit, to a UE via MAC-CE, a deactivation of the SCell indicated for transmitting the PUCCH. For example, as illustrated in FIG. 12, a UE may receive, from the network entity via MAC-CE, a deactivation of the SCell indicated for transmitting the PUCCH. In some aspects, 1804 may be performed by fallback component 2144 of FIG. 21.

At 1806, the network entity (e.g., base station or a component of a base station) may receive, from the UE, an adjusted transmission of the PUCCH in the resources of the SCell based on the deactivation of the SCell. For example, as illustrated in FIG. 12, a UE may adjust transmission of the PUCCH in the resources of the SCell based on the deactivation of the SCell and the network entity (e.g., base station) may receive the adjusted transmission. In some aspects, 1806 may be performed by fallback component 2144 of FIG. 21. In some aspects, adjustment of the transmission of the PUCCH in the resources of the SCell includes transmission of the PUCCH to the network entity (e.g., base station) based on a fallback pattern. In some aspects, the network entity (e.g., base station) may transmit a fallback pattern configuration to the UE. In some aspects, the fallback pattern comprises a fallback time pattern. In some aspects, the fallback pattern defines a cell fallback list indicating one or more cells, and the network entity (e.g., base station) may use one cell of the one or more cells to receive the PUCCH.

In some aspects, the network entity (e.g., base station or a component of a base station) may further transmit, to the UE via MAC-CE, a reactivation of the SCell indicated for transmitting the PUCCH. The base station may receive the PUCCH based on the time pattern after the reactivation of the SCell.

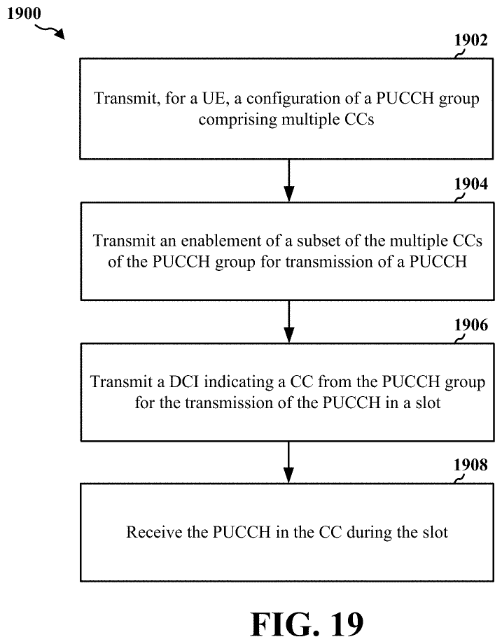

FIG. 19 is a flowchart 1900 of a method of wireless communication. The method may be performed by a network entity, such as a base station (e.g., the base station 180 of FIG. 1, 310 of FIG. 3; the CU 2210, DU 2230 and/or RU 2240 of FIG. 22; the apparatus 2102 of FIG. 21). The method may be used for reducing signaling overhead in DCI.

At 1902, the network entity (e.g., base station or a component of a base station) may transmit, to a UE, a configuration of a PUCCH group comprising multiple CCs. For example, as illustrated in FIG. 13, a base station may transmit, to a UE, a configuration of a PUCCH group 1325 comprising multiple CCs. In some aspects, 1902 may be performed by the codepoint component 2146 of FIG. 21.

At 1904, the network entity (e.g., base station or a component of a base station) may transmit an enablement of a subset of the multiple CCs of the PUCCH group for transmission of a PUCCH. For example, as illustrated in FIG. 13, a base station may transmit an enablement of a subset of the multiple CCs (including PCC 1302 and SCC 1306, 1308, and 1312) of the PUCCH group for transmission of a PUCCH. In some aspects, 1904 may be performed by the codepoint component 2146 of FIG. 21.

At 1906, the network entity (e.g., base station or a component of a base station) may transmit a DCI indicating a CC from the PUCCH group for the transmission of the PUCCH in a slot. For example, the base station may transmit a DCI indicating a CC from the PUCCH group for the transmission of the PUCCH in a slot (such as one of PCC 1302 and SCC 1306, 1308, and 1312). In some aspects, 1906 may be performed by the codepoint component 2146 of FIG. 21. In some aspects, the DCI indicates the CC from the subset of the multiple CCs of the PUCCH group that are enabled. In some aspects, the DCI comprises a codepoint mapped to one of the multiple CCs of the PUCCH group. In some aspects, the DCI comprises a codepoint mapped to one cell within the subset of cells enabled for the transmission of the PUCCH.

At 1908, the network entity (e.g., base station or a component of a base station) may receive the PUCCH from the UE in the CC during the slot. For example, as illustrated in FIG. 13, a base station may receive the PUCCH from the UE in the CC (such as one of PCC 1302 and SCC 1306, 1308, and 1312 of FIG. 13) during the slot. In some aspects, 1908 may be performed by the codepoint component 2146 of FIG. 21.

FIG. 20 is a diagram 2000 illustrating an example of a hardware implementation for an apparatus 2002. The apparatus 2002 may be a UE, a component of a UE, or may implement UE functionality. In some aspects, the apparatus 2002 may include a cellular baseband processor 2004 (also referred to as a modem) coupled to a cellular RF transceiver 2022. In some aspects, the apparatus 2002 may further include one or more subscriber identity modules (SIM) cards 2020, an application processor 2006 coupled to a secure digital (SD) card 2008 and a screen 2010, a Bluetooth module 2012, a wireless local area network (WLAN) module 2014, a Global Positioning System (GPS) module 2016, or a power supply 2018. The cellular baseband processor 2004 communicates through the cellular RF transceiver 2022 with the UE 104 and/or BS 102/180. The cellular baseband processor 2004 may include a computer-readable medium/memory. The computer-readable medium/memory may be non-transitory. The cellular baseband processor 2004 is responsible for general processing, including the execution of software stored on the computer-readable medium/memory. The software, when executed by the cellular baseband processor 2004, causes the cellular baseband processor 2004 to perform the various functions described supra. The computer-readable medium/memory may also be used for storing data that is manipulated by the cellular baseband processor 2004 when executing software. The cellular baseband processor 2004 further includes a reception component 2030, a communication manager 2032, and a transmission component 2034. The communication manager 2032 includes the one or more illustrated components. The components within the communication manager 2032 may be stored in the computer-readable medium/memory and/or configured as hardware within the cellular baseband processor 2004. The cellular baseband processor 2004 may be a component of the UE 350 and may include the memory 360 and/or at least one of the TX processor 368, the RX processor 356, and the controller/processor 359. In one configuration, the apparatus 2002 may be a modem chip and include just the cellular baseband processor 2004, and in another configuration, the apparatus 2002 may be the entire UE (e.g., see 350 of FIG. 3) and include the additional modules of the apparatus 2002.

The communication manager 2032 may include a spatial component 2042 that is configured to receive, from a network entity (e.g., base station) via MAC-CE, a mapping between a PUCCH spatial relation information and a plurality of PUCCH resources associated with one or more CCs and transmit a PUCCH to the network entity (e.g., base station) based on the mapping, e.g., as described in connection with FIG. 14. The communication manager 2032 may further include a fallback component 2044 that may be configured to receive, from a network entity (e.g., base station) via RRC, a time pattern for transmitting a PUCCH including resources of a SCell, receive, from the network entity (e.g., base station) via MAC-CE, a deactivation of the SCell indicated for transmitting the PUCCH, and adjust transmission of the PUCCH in the resources of the SCell based on the deactivation of the SCell, e.g., as described in connection with FIG. 15. The communication manager 2032 may further include a codepoint component 2046 that may be configured to receive, from a network entity (e.g., base station), a configuration of a PUCCH group comprising multiple CCs, receive an enablement of a subset of the multiple CCs of the PUCCH group for transmission of a PUCCH, receive a DCI indicating a CC from the PUCCH group for the transmission of the PUCCH in a slot, and transmit the PUCCH to the network entity (e.g., base station) in the CC during the slot, e.g., as described in connection with FIG. 16.

The apparatus may include additional components that perform each of the blocks of the algorithm in the flowcharts of FIGS. 14-16. As such, each block in the flowcharts of FIGS. 14-16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2002 may include a variety of components configured for various functions. In one configuration, the apparatus 2002, and in particular the cellular baseband processor 2004, may include means for receiving, from a network entity (e.g., base station) via MAC-CE, a mapping between a PUCCH spatial relation information and a plurality of PUCCH resources associated with one or more CCs. The cellular baseband processor 2004 may further include means for transmitting a PUCCH to the network entity (e.g., base station) based on the mapping. The cellular baseband processor 2004 may further include means for receiving, from a network entity (e.g., base station) via RRC, a time pattern for transmitting a PUCCH including resources of a SCell. The cellular baseband processor 2004 may further include means for receiving, from the network entity (e.g., base station) via MAC-CE, a deactivation of the SCell indicated for transmitting the PUCCH. The cellular baseband processor 2004 may further include means for adjusting transmission of the PUCCH in the resources of the SCell based on the deactivation of the SCell. The cellular baseband processor 2004 may further include means for skipping the transmission of the PUCCH in the resources based on the deactivation of the SCell. The cellular baseband processor 2004 may further include means for receiving a fallback pattern configuration from the network entity (e.g., base station). The cellular baseband processor 2004 may further include means for receiving, from the network entity (e.g., base station) via MAC-CE, a reactivation of the SCell indicated for transmitting the PUCCH. The cellular baseband processor 2004 may further include means for transmitting the PUCCH based on the time pattern after the reactivation of the SCell. The cellular baseband processor 2004 may further include means for receiving, from a network entity (e.g., base station), a configuration of a PUCCH group comprising multiple CCs. The cellular baseband processor 2004 may further include means for receiving an enablement of a subset of the multiple CCs of the PUCCH group for transmission of a PUCCH. The cellular baseband processor 2004 may further include means for receiving a DCI indicating a CC from the PUCCH group for the transmission of the PUCCH in a slot. The cellular baseband processor 2004 may further include means for transmitting the PUCCH to the network entity (e.g., base station) in the CC during the slot. The means may be one or more of the components of the apparatus 2002 configured to perform the functions recited by the means. As described supra, the apparatus 2002 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 21 is a diagram 2100 illustrating an example of a hardware implementation for an apparatus 2102. The apparatus 2102 may be a network entity, such as a base station, a component of a base station, or may implement base station functionality. In some aspects, the apparatus 2002 may include a baseband unit 2104. The baseband unit 2104 may communicate through a cellular RF transceiver 2122 with the UE 104. The baseband unit 2104 may include a computer-readable medium/memory. The baseband unit 2104 is responsible for general processing, including the execution of software stored on the computer-readable medium/memory. The software, when executed by the baseband unit 2104, causes the baseband unit 2104 to perform the various functions described supra. The computer-readable medium/memory may also be used for storing data that is manipulated by the baseband unit 2104 when executing software. The baseband unit 2104 further includes a reception component 2130, a communication manager 2132, and a transmission component 2134. The communication manager 2132 includes the one or more illustrated components. The components within the communication manager 2132 may be stored in the computer-readable medium/memory and/or configured as hardware within the baseband unit 2104. The baseband unit 2104 may be a component of the base station 310 and may include the memory 376 and/or at least one of the TX processor 316, the RX processor 370, and the controller/processor 375.

The communication manager 2132 may include a spatial component 2142 that may transmit, to a UE via MAC-CE, a mapping between a PUCCH spatial relation information and a plurality of PUCCH resources associated with one or more CCs and receive a PUCCH from the UE based on the mapping, e.g., as described in connection with FIG. 17. The communication manager 2132 further may include a fallback component 2144 that may transmit, to a UE via RRC, a time pattern for transmitting a PUCCH including resources of a SCell, transmit, to the UE via MAC-CE, a deactivation of the SCell indicated for transmitting the PUCCH, and receive a transmission of the PUCCH in the resources of the SCell based on the deactivation of the SCell, e.g., as described in connection with FIG. 18. The communication manager 2132 further may include a codepoint component 2146 that may transmit, to a UE, a configuration of a PUCCH group comprising multiple CCs, transmit an enablement of a subset of the multiple CCs of the PUCCH group for transmission of a PUCCH, transmit a DCI indicating a CC from the PUCCH group for the transmission of the PUCCH in a slot, and receive the PUCCH from the UE in the CC during the slot, e.g., as described in connection with FIG. 19.

The apparatus may include additional components that perform each of the blocks of the algorithm in the flowcharts of FIGS. 17-19. As such, each block in the flowcharts of FIGS. 17-19 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2102 may include a variety of components configured for various functions. In one configuration, the apparatus 2102, and in particular the baseband unit 2104, may include means for transmitting, to a UE via MAC-CE, a mapping between a PUCCH spatial relation information and a plurality of PUCCH resources associated with one or more CCs. The baseband unit 2104 may further include means for receiving a PUCCH from the UE based on the mapping. The baseband unit 2104 may further include means for transmitting, to a UE via RRC, a time pattern for transmitting a PUCCH including resources of a SCell. The baseband unit 2104 may further include means for transmitting, to the UE via MAC-CE, a deactivation of the SCell indicated for transmitting the PUCCH. The baseband unit 2104 may further include means for receiving a transmission of the PUCCH in the resources of the SCell based on the deactivation of the SCell. The baseband unit 2104 may further include means for transmitting a fallback pattern configuration to the UE. The baseband unit 2104 may further include means for transmitting, to the UE via MAC-CE, a reactivation of the SCell indicated for transmitting the PUCCH. The baseband unit 2104 may further include means for transmitting the PUCCH based on the time pattern after the reactivation of the SCell. The baseband unit 2104 may further include means for transmitting an enablement of a subset of the multiple CCs of the PUCCH group for transmission of a PUCCH. The baseband unit 2104 may further include means for transmitting, to a UE, a configuration of a PUCCH group comprising multiple CCs. The baseband unit 2104 may further include means for transmitting a DCI indicating a CC from the PUCCH group for the transmission of the PUCCH in a slot. The baseband unit 2104 may further include means for receiving the PUCCH from the UE in the CC during the slot. The means may be one or more of the components of the apparatus 2102 configured to perform the functions recited by the means. As described supra, the apparatus 2102 may include the TX Processor 316, the RX Processor 370, and the controller/processor 375. As such, in one configuration, the means may be the TX Processor 316, the RX Processor 370, and the controller/processor 375 configured to perform the functions recited by the means.

FIG. 22 shows a diagram illustrating an example disaggregated base station 2200 architecture. The disaggregated base station 2200 architecture may include one or more central units (CUs) 2210 that can communicate directly with a core network 2220 via a backhaul link, or indirectly with the core network 2220 through one or more disaggregated base station units (such as a Near-Real Time (Near-RT) RAN Intelligent Controller (RIC) 2225 via an E2 link, or a Non-Real Time (Non-RT) RIC 2215 associated with a Service Management and Orchestration (SMO) Framework 2205, or both). A CU 2210 may communicate with one or more distributed units (DUs) 2230 via respective midhaul links, such as an F1 interface. The DUs 2230 may communicate with one or more radio units (RUs) 2240 via respective fronthaul links. The RUs 2240 may communicate with respective UEs 2222 via one or more radio frequency (RF) access links. In some implementations, the UE 2222 may be simultaneously served by multiple RUs 2240.

Each of the units, i.e., the CUs 2210, the DUs 2230, the RUs 2240, as well as the Near-RT RICs 2225, the Non-RT RICs 2215 and the SMO Framework 2205, may include one or more interfaces or be coupled to one or more interfaces configured to receive or transmit signals, data, or information (collectively, signals) via a wired or wireless transmission medium. The units may collectively be referred to as a “network entity.” Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 2210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 2210. The CU 2210 may be configured to handle user plane functionality (i.e., Central Unit-User Plane (CU-UP)), control plane functionality (i.e., Central Unit-Control Plane (CU-CP)), or a combination thereof. In some implementations, the CU 2210 can be logically split into one or more CU-UP units and one or more CU-CP units. The CU-UP unit can communicate bidirectionally with the CU-CP unit via an interface, such as the E1 interface when implemented in an O-RAN configuration. The CU 2210 can be implemented to communicate with the DU 2230, as necessary, for network control and signaling.

The DU 2230 may correspond to a logical unit that includes one or more base station functions to control the operation of one or more RUs 2240. In some aspects, the DU 2230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 2230 may further host one or more low PHY layers. Each layer (or module) can be implemented with an interface configured to communicate signals with other layers (and modules) hosted by the DU 2230, or with the control functions hosted by the CU 2210.

Lower-layer functionality can be implemented by one or more RUs 2240. In some deployments, an RU 2240, controlled by a DU 2230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 2240 can be implemented to handle over the air (OTA) communication with one or more UEs 2222. In some implementations, real-time and non-real-time aspects of control and user plane communication with the RU(s) 2240 can be controlled by the corresponding DU 2230. In some scenarios, this configuration can enable the DU(s) 2230 and the CU 2210 to be implemented in a cloud-based RAN architecture, such as a vRAN architecture.

The SMO Framework 2205 may be configured to support RAN deployment and provisioning of non-virtualized and virtualized network elements. For non-virtualized network elements, the SMO Framework 2205 may be configured to support the deployment of dedicated physical resources for RAN coverage requirements which may be managed via an operations and maintenance interface (such as an O1 interface). For virtualized network elements, the SMO Framework 2205 may be configured to interact with a cloud computing platform (such as an open cloud (O-Cloud) 2290) to perform network element life cycle management (such as to instantiate virtualized network elements) via a cloud computing platform interface (such as an O2 interface). Such virtualized network elements can include, but are not limited to, CUs 2210, DUs 2230, RUs 2240 and Near-RT RICs 2225. In some implementations, the SMO Framework 2205 can communicate with a hardware aspect of a 4G RAN, such as an open eNB (O-eNB) 2211, via an O1 interface. Additionally, in some implementations, the SMO Framework 2205 can communicate directly with one or more RUs 2240 via an O1 interface. The SMO Framework 2205 also may include a Non-RT RIC 2215 configured to support functionality of the SMO Framework 2205.

The Non-RT RIC 2215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 2225. The Non-RT RIC 2215 may be coupled to or communicate with (such as via an A1 interface) the Near-RT RIC 2225. The Near-RT RIC 2225 may be configured to include a logical function that enables near-real-time control and optimization of RAN elements and resources via data collection and actions over an interface (such as via an E2 interface) connecting one or more CUs 2210, one or more DUs 2230, or both, as well as an O-eNB, with the Near-RT RIC 2225.

In some implementations, to generate AI/ML models to be deployed in the Near-RT RIC 2225, the Non-RT RIC 2215 may receive parameters or external enrichment information from external servers. Such information may be utilized by the Near-RT RIC 2225 and may be received at the SMO Framework 2205 or the Non-RT RIC 2215 from non-network data sources or from network functions. In some examples, the Non-RT RIC 2215 or the Near-RT RIC 2225 may be configured to tune RAN behavior or performance. For example, the Non-RT RIC 2215 may monitor long-term trends and patterns for performance and employ AI/ML models to perform corrective actions through the SMO Framework 2205 (such as reconfiguration via O1) or via creation of RAN management policies (such as Al policies).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” or “based at least in part on A,”.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

Aspect 1 is a method for wireless communication at a UE, comprising: receiving, from a network entity via MAC-CE, a mapping between a PUCCH spatial relation information and a plurality of PUCCH resources associated with one or more CCs; and transmitting a PUCCH to the network entity based on the mapping.

Aspect 2 is the method of aspect 1, wherein each of the plurality of PUCCH resources is associated with a same PUCCH resource ID, and wherein each of the plurality of PUCCH resources is associated with a different CC of the one or more CCs.

Aspect 3 is the method of any of aspects 1-2, wherein a plurality of CCs is configured by the network entity via RRC.

Aspect 4 is the method of any of aspects 1-3, wherein the plurality of PUCCH resources is associated with more than one PUCCH resource ID, and wherein the more than one PUCCH resource ID are associated with at least one group.

Aspect 5 is the method of any of aspects 1-4, wherein each group of the at least one group is associated with one CC of the one or more CCs.

Aspect 6 is a method for wireless communication at a UE, comprising: receiving, from a network entity via RRC, a time pattern for transmitting a PUCCH including resources of a SCell; receiving, from the network entity via MAC-CE, a deactivation of the SCell indicated for transmitting the PUCCH; and adjusting transmission of the PUCCH in the resources of the SCell based on the deactivation of the SCell.

Aspect 7 is the method of aspect 6, wherein adjusting the transmission of the PUCCH in the resources of the SCell comprises skipping the transmission of the PUCCH in the resources based on the deactivation of the SCell.

Aspect 8 is the method of any of aspects 6-7, wherein adjustment of the transmission of the PUCCH in the resources of the SCell includes transmission of the PUCCH to the network entity based on a fallback pattern.

Aspect 9 is the method of any of aspects 6-8, further comprising receiving a fallback pattern configuration from the network entity.

Aspect 10 is the method of aspect 8, wherein the fallback pattern comprises a fallback time pattern.

Aspect 11 is the method of any of aspects 8-10, wherein the fallback pattern defines a cell fallback list indicating one or more cells, and wherein the UE uses one cell of the one or more cells to transmit the PUCCH.

Aspect 12 is the method of any of aspects 6-11, further comprising: receiving, from the network entity via MAC-CE, a reactivation of the SCell indicated for transmitting the PUCCH; and transmitting the PUCCH based on the time pattern after the reactivation of the SCell.

Aspect 13 is a method for wireless communication at a UE, comprising: receiving, from a network entity, a configuration of a PUCCH group comprising multiple CCs; receiving an enablement of a subset of the multiple CCs of the PUCCH group for transmission of a PUCCH; receiving a DCI indicating a CC from the PUCCH group for the transmission of the PUCCH in a slot; and transmitting the PUCCH to the network entity in the CC during the slot.

Aspect 14 is the method of aspect 13, wherein the DCI indicates the CC from the subset of the multiple CCs of the PUCCH group that are enabled.

Aspect 15 is the method of any of aspects 13-14, wherein the DCI comprises a codepoint mapped to one of the multiple CCs of the PUCCH group.

Aspect 16 is the method of any of aspects 13-15, wherein the DCI comprises a codepoint mapped to one cell within the subset of cells enabled for the transmission of the PUCCH.

Aspect 17 is a method for wireless communication at a network entity, comprising:

transmitting, to a UE via MAC-CE, a mapping between a PUCCH spatial relation information and a plurality of PUCCH resources associated with one or more CCs;

and receive a PUCCH from the UE based on the mapping.

Aspect 18 is the method of aspect 17, wherein each of the plurality of PUCCH resources is associated with a same PUCCH resource ID associated, and wherein each of the plurality of PUCCH resources is associated with a different CC of the one or more CCs.

Aspect 19 is the method of any of aspects 17-18, wherein the plurality of CC is configured by the network entity via RRC.

Aspect 20 is the method of any of aspects 17-19, wherein the plurality of PUCCH resources is associated with more than one PUCCH resource ID, and wherein the more than one PUCCH resource ID are associated with at least one group.

Aspect 21 is the method of any of aspects 17-20, wherein each group of the at least one group is associated with one CC of the one or more CCs.

Aspect 22 is a method for wireless communication at a network entity, comprising:

transmitting, to a UE via RRC, a time pattern for transmitting a PUCCH including resources of a SCell; transmitting, to the UE via MAC-CE, a deactivation of the SCell indicated for transmitting the PUCCH; and receiving a transmission of the PUCCH in the resources of the SCell based on the deactivation of the SCell.

Aspect 23 is the method of aspect 22, wherein adjustment of the transmission of the PUCCH in the resources of the SCell includes transmission of the PUCCH to the network entity based on a fallback pattern.

Aspect 24 is the method of any of aspects 22-23, further comprising: transmitting a fallback pattern configuration to the UE.

Aspect 25 is the method of any of aspects 23-24, wherein the fallback pattern comprises a fallback time pattern.

Aspect 26 is the method of any of aspects 23-25, wherein the fallback pattern defined a cell fallback list indicating one or more cells, and wherein the UE uses one cell of the one or more cells to transmit the PUCCH.

Aspect 27 is the method of any of aspects 22-26, further comprising: transmitting, to the UE via MAC-CE, a reactivation of the SCell indicated for transmitting the PUCCH; and transmitting the PUCCH based on the time pattern after the reactivation of the SCell.

Aspect 28 is a method for wireless communication at a network entity, comprising: transmitting, to a UE, a configuration of a PUCCH group comprising multiple CCs; transmitting an enablement of a subset of the multiple CCs of the PUCCH group for transmission of a PUCCH; transmitting a DCI indicating a CC from the PUCCH group for the transmission of the PUCCH in a slot; and receiving the PUCCH from the UE in the CC during the slot.

Aspect 29 is the method of aspect 28, wherein the DCI indicates the CC from the subset of the multiple CCs of the PUCCH group that are enabled.

Aspect 30 is the method of any of aspects 28-29, wherein the DCI comprises a codepoint mapped to one of the multiple CCs of the PUCCH group.

Aspect 31 is the method of any of aspects 28-30, wherein the DCI comprises a codepoint mapped to one cell within the subset of cells enabled for the transmission of the PUCCH.

Aspect 32 is an apparatus for wireless communication at a UE including a memory and at least one processor coupled to the memory and, based at least in part on information stored in the memory, configured to perform a method in accordance with any of aspects 1-16. The apparatus may include at least one of a transceiver or an antenna coupled to the at least one processor.

Aspect 33 is an apparatus for wireless communications, including means for performing a method in accordance with any of aspects 1-16.

Aspect 34 is a non-transitory computer-readable medium including instructions that, when executed by an apparatus, cause the apparatus to perform a method in accordance with any of aspects 1-16.

Aspect 35 is an apparatus for wireless communication at a network entity including a memory and at least one processor coupled to the memory and, based at least in part on information stored in the memory, configured to perform a method in accordance with any of aspects 17-31. The apparatus may include at least one of a transceiver or an antenna coupled to the at least one processor.

Aspect 36 is an apparatus for wireless communications, including means for performing a method in accordance with any of aspects 17-31.

Aspect 37 is a non-transitory computer-readable medium including instructions that, when executed by an apparatus, cause the apparatus to perform a method in accordance with any of aspects 17-31.

What is claimed is:

1. An apparatus for wireless communication at a user equipment (UE), comprising:
a memory; and
at least one processor coupled to the memory and, based at least in part on information stored in the memory, the at least one processor is configured to:
receive, from a network entity via medium access control (MAC) control element (CE), a mapping between a physical uplink control channel (PUCCH) spatial relation information and a plurality of PUCCH resources associated with one or more component carriers (CCs); and
transmit a PUCCH to the network entity based on the mapping.

2. The apparatus of claim 1, wherein each of the plurality of PUCCH resources is associated with a same PUCCH resource identifier (ID), and wherein each of the plurality of PUCCH resources is associated with a different CC of the one or more CCs.

3. The apparatus of claim 2, wherein a plurality of CCs is configured by the network entity via radio resource control (RRC).

4. The apparatus of claim 2, wherein the plurality of PUCCH resources is associated with more than one PUCCH resource identifier (ID), and wherein the more than one PUCCH resource ID are associated with at least one group.

5. The apparatus of claim 4, wherein each group of the at least one group is associated with one CC of the one or more CCs.

6. The apparatus of claim 1, further comprising a transceiver coupled to the at least one processor.

7. An apparatus for wireless communication at a user equipment (UE), comprising:
a memory; and
at least one processor coupled to the memory and, based at least in part on information stored in the memory, the at least one processor is configured to:
receive, from a network entity via radio resource control (RRC), a time pattern for transmitting a physical uplink control channel (PUCCH) including resources of a secondary cell (SCell);
receive, from the network entity via medium access control (MAC) control element (CE), a deactivation of the SCell indicated for transmitting the PUCCH; and
adjust transmission of the PUCCH in the resources of the SCell based on the deactivation of the SCell.

8. The apparatus of claim 7, wherein to adjust the transmission of the PUCCH in the resources of the SCell, the memory and the at least one processor are further configured to:
skip the transmission of the PUCCH in the resources based on the deactivation of the SCell.

9. The apparatus of claim 7, wherein adjustment of the transmission of the PUCCH in the resources of the SCell includes the transmission of the PUCCH to the network entity based on a fallback pattern.

10. The apparatus of claim 9, wherein the memory and the at least one processor are further configured to:
receive a fallback pattern configuration from the network entity.

11. The apparatus of claim 9, wherein the fallback pattern comprises a fallback time pattern.

12. The apparatus of claim 9, wherein the fallback pattern defines a cell fallback list indicating one or more cells, and wherein the UE uses one cell of the one or more cells to transmit the PUCCH.

13. The apparatus of claim 7, wherein the memory and the at least one processor are further configured to:
receive, from the network entity via an additional MAC-CE, a reactivation of the SCell indicated for transmitting the PUCCH; and
transmit the PUCCH based on the time pattern after the reactivation of the SCell.

14. An apparatus for wireless communication at a network entity, comprising:
a memory; and
at least one processor coupled to the memory and, based at least in part on information stored in the memory, the at least one processor is configured to:
transmit, for a user equipment (UE) via radio resource control (RRC), a time pattern for transmitting a physical uplink control channel (PUCCH) including resources of a secondary cell (SCell);
transmit, for the UE via medium access control (MAC) control element (CE), a deactivation of the SCell indicated for transmitting the PUCCH; and
receive an adjusted transmission of the PUCCH in the resources of the SCell based on the deactivation of the SCell.

15. The apparatus of claim 14, further comprising a transceiver coupled to the at least one processor.

16. The apparatus of claim 14, wherein the adjusted transmission of the PUCCH in the resources of the SCell includes transmission of the PUCCH to the network entity based on a fallback pattern.

17. The apparatus of claim 16, wherein the memory and the at least one processor are further configured to:
transmit a fallback pattern configuration for the UE.

18. The apparatus of claim 17, wherein the fallback pattern comprises a fallback time pattern.

19. The apparatus of claim 17, wherein the fallback pattern defines a cell fallback list indicating one or more cells, and wherein the UE uses one cell of the one or more cells to transmit the PUCCH.

20. The apparatus of claim 14, wherein the memory and the at least one processor are further configured to:
transmit, for the UE via an additional MAC-CE, a reactivation of the SCell indicated for transmitting the PUCCH; and
receive the PUCCH based on the time pattern after the reactivation of the SCell.

21. A method for wireless communication at a user equipment (UE), comprising:
receiving, from a network entity via radio resource control (RRC), a time pattern for transmitting a physical uplink control channel (PUCCH) including resources of a secondary cell (SCell);
receiving, from the network entity via medium access control (MAC) control element (CE), a deactivation of the SCell indicated for transmitting the PUCCH; and
adjusting transmission of the PUCCH in the resources of the SCell based on the deactivation of the SCell.

22. The method of claim 21, wherein to adjust the transmission of the PUCCH in the resources of the SCell, the method further comprising:
skipping the transmission of the PUCCH in the resources based on the deactivation of the SCell.

23. The method of claim 21, wherein adjustment of the transmission of the PUCCH in the resources of the SCell includes the transmission of the PUCCH to the network entity based on a fallback pattern.

24. The method of claim 23, further comprising:
receiving a fallback pattern configuration from the network entity.

25. The method of claim 23, wherein the fallback pattern comprises a fallback time pattern.

26. The method of claim 23, wherein the fallback pattern defines a cell fallback list indicating one or more cells, and wherein the UE uses one cell of the one or more cells to transmit the PUCCH.

27. The method of claim 21, further comprising:
receiving, from the network entity via an additional MAC-CE, a reactivation of the SCell indicated for transmitting the PUCCH; and
transmitting the PUCCH based on the time pattern after the reactivation of the SCell.
